(19) United States
(12) Patent Application Publication
(10) Pub. No.: US 2011/0249022 A1
(43) Pub. Date: Oct. 13, 2011

(54) TECHNIQUES FOR MANAGING POWER USE

(76) Inventors: Rajesh Poornachandran, Beaverton, OR (US); Michael D. Rosenzweig, Hopkinton, MA (US)

(21) Appl. No.: 12/756,327

(22) Filed: Apr. 8, 2010

(51) Int. Cl. G09G 5/00; G06T 1/00

(52) U.S. Cl. 345/619; 345/522

(57) ABSTRACT

Techniques are described that can be used to manage drawing requests from applications based in part on whether the drawing requests can be displayed and in part on the power consumption states of hardware in the system. If the drawing request can not be displayed, then a number of responses can take place. For example, instead of providing the drawing request to hardware and the driver provides a zero pixel region to the hardware. In some cases, the driver saves the state changes that would have resulted had the drawing request been performed and the drawing request is rendered to a buffer instead of the hardware being powered-on. Other examples are described herein.

### FIELD

The subject matter disclosed herein relates generally to conserving power consumption when graphics are requested to be displayed.

### RELATED ART

In smart phones and mobile computing devices, power management takes place when there is no user activity for a specified period of time or when there is some other external factor that requests the device to enter a low power state. Power management techniques monitor device use and attempt to put the platform sub-systems into appropriate low power states for the supported use cases. To save power aggressively, a graphics driver (or the display driver) turns off the display based on user activity, regardless of whether the graphics and video hardware accelerator engines are in use. In addition, foreground and background applications running in the platform are not always aware of power management in place and may continue to request access to video and graphics accelerators. Applications may be unaware of low power states of hardware because either the operating system (OS) or graphics system do not have the capability to notify applications about low power state transitions, applications are not interested in being notified and they do not register with the platform power manager/operating system, or the application ignores the power management notifications. Despite the display being powered-off, applications can request use of graphics and video accelerators, which turns-on graphics and video accelerators and results in unnecessary power consumption because requested output (images and video) are not visible to the end user and are therefore result in wasted work.

### BRIEF DESCRIPTION OF THE DRAWINGS

Embodiments of the present invention are illustrated by way of example, and not by way of limitation, in the drawings and in which like reference numerals refer to similar elements.

FIG. 1 shows a system architecture according to various embodiments.

FIG. 2 shows an interaction between a graphics driver, application, and power manager.

FIG. 3 depicts a process in which a driver causes the target region to be zero pixels in size when a request for drawing will not be displayed.

FIG. 4 depicts a process in which the graphics driver determines whether the application that requests the drawing also relies on previously rendered content.

FIG. 5 depicts an example process that can be used to distinguish between applications that utilize graphics hardware and those that do not use graphics hardware and handle powering-on of hardware and instructions to hardware appropriately.

FIG. 6 depicts a system in which a power manager (PM) and applications are involved in communications concerning power-down states of hardware in the platform.

FIG. 7 depicts a system in accordance with an embodiment.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In various embodiments, a graphics driver or other logic manages requests from an application to reduce powering-up graphics acceleration hardware when a display is powered-off or the display is configured to not display content on a screen where the application requests content requested to be displayed. The driver captures the application's state changes but does not call the graphics or video hardware engines to render the target. Instead, the graphics or video hardware engines are called to write out zero pixels.

In various embodiments, the driver does not power-on or power-up hardware to process the draw call and the hardware does not render the draw call. The driver updates state changes in a manner requested by the application in the driver's data structures. When the system powers-up, a power manager (PM) notifies the graphics window manager to refresh its client windows and the correct state is restored based on the states stored by the driver. In some cases, the power manager notifies the window manager during system resume to refresh all the application's windows so they are in the expected state. Once the subsystem wakes up, then PM notifies all applications to refresh the woken-up subsystem so that driver does not have to keep track of state of subsystems thereafter.

In various embodiments, if the application accesses previously rendered drawings resulting from previous draw calls, the driver requests storing of at least one frame previously requested to be rendered. The application renders undisplayable content to a buffer so that later, hardware can remain powered off (or in lower power state) and the buffered content is transferred to the application's buffer. In addition, the driver captures the application's state changes in case hardware that is to be used can remain powered-off (or in lower power state).

In various embodiments, the driver distinguishes between applications whose requests can be performed without powering-on hardware and those whose requests are performed using acceleration hardware. For requests that can be performed without using acceleration hardware, the graphics driver keeps track of state changes but does not cause the acceleration hardware to be powered-on. The central processing unit (CPU) can be used instead of the acceleration for low-complexity image rendering. In some cases, use of the acceleration hardware or the CPU is dependent on the properties of the system as well as the workload being rendered. In some cases, 3D frames have very small delta in their work load between frames. Based on this assumption, one approach is to guess the amount of the “next” workload based on a prior work load. Use of the hardware engine can occur when the expected workload is sufficiently large.

In various embodiments, the system enables two-way communication between the power manager and applications. Applications request that the power manager notify the applications when an acceleration hardware element is powered-down (or in lower power state). The power manager tells the applications not to transmit commands for drawing images to the powered-down subsystem or graphics acceleration hardware. Applications also notify the power manager of the application's inactivity so that the power manager can transition the platform into low power state even before a user inactivity timer causes powering-down of acceleration hardware. This can cause significant power savings.

In some cases, when a screen saver is operating on the display, hardware accelerators are powered-down. However, in some cases, a 3D screen saver for example may consume less power if rendered using hardware accelerators than using software executed by a CPU. Accordingly, if a 3D screen saver is used, then hardware accelerators are used.

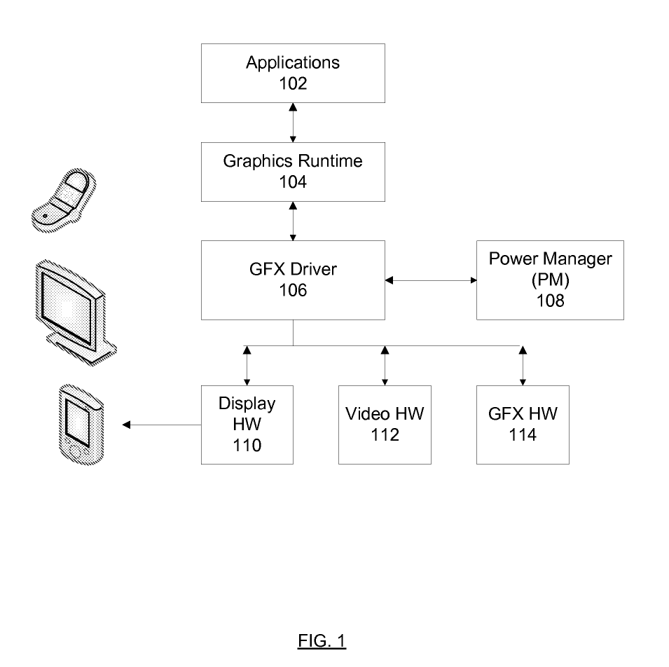

FIG. 1 shows a system architecture according to various embodiments. Applications 102 are software that provide graphics drawing requests for 2-D, 3-D images, and video. Applications 102 may be unaware that the display is powered-down or an image requested to be displayed will not be displayed. Applications 102 may also be unaware of whether the hardware in the system is powered-down or in lower power states.

Graphics (GFX) runtime block 104 receives higher level commands and translates those commands to lower level commands for GFX driver 106. GFX runtime block 104 provides APIs that applications use to draw. GFX runtime block 104 reduces the porting effort required for an application to run across multiple OS. Graphics runtime block 104 can be operable with Windows, Linux, and other operating systems. For example, graphics runtime block 104 can be implemented as a DirectX or OpenGL compatible logic.

GFX driver block 106 is a software layer that is an interface among applications 102, graphics runtime 104, power manager 108, and hardware (HW) acceleration devices. Applications provide graphics operation requests to GFX driver block 106. In some cases, applications do not know that hardware is powered-off or know that requested drawings will not be visible such as when covered by another object or a screen saver is operating. GFX driver block 106 controls rendering of images and video as well as hardware that drives display of images and video. GFX driver block 106 translates the application's run time requests into hardware commands. In some cases, GFX driver block 106 powers-on the hardware to perform the request. In some cases, GFX driver block 106 interacts with PM 108 to drive the platform hardware into lower power state. For example, the following provides example power-use states:

### Device Specific Low-Power States for any of GFX HW or Video HW or Display HW:

D1: sub-system completely powered OFF.
D0: sub-system in full operational mode (ON).
D0i1: sub-system ON with clock gating.
D0i3: sub-system ON with power gating.

### System Level Sleep States (Sx or S0ix) and Includes all Platform Sub-Systems:

S0: Platform is On and all subsystems are in fully powered state.
S0i1: Active Standby/Always-ON-Always-Connected (AOAC) Standby; used during short idle periods (user is interactively using the device).
S0i2: Active Standby; used during extended idle periods (user passively using the device).
S0i3: Sleep; user is not using the device.

### S3: Suspend.

### S4: Hibernate.

S5: Fully powered OFF.

Power manager (PM) block 108 manages hardware power consumption in the platform. For example, if a period of time elapses that the display is not used or there is no user interaction, PM block 108 powers down one or more of display hardware 110, video hardware 112, and graphics (GFX) hardware 114. In addition, PM block 108 may power down the display or request display of a screen saver. Powering-down can encompass reducing power consumption of the hardware according to the Dx, D0x, Sx, or SiOx states described earlier.

Video HW block 112 can include video encoding and video decoding hardware engines in accordance with applicable video compression and de-compression standards. For example, video HW block 112 can provide compression and de-compression in accordance with any of MPEG-2, MPEG-4, H.263, H.264, and the emerging H.265 standard. GFX HW block 114 can be 2D or 3D graphics accelerator hardware. For example, GFX HW block 114 can be 2D or 3D graphics accelerator hardware for DirectX or OpenGL graphics pipelines. Display hardware (HW) block 110 receives content generated by video HW block 112 or GFX HW block 114 and formats the content for display on a panel. Each of blocks 110-114 is capable of entering powered-down or reduced power modes.

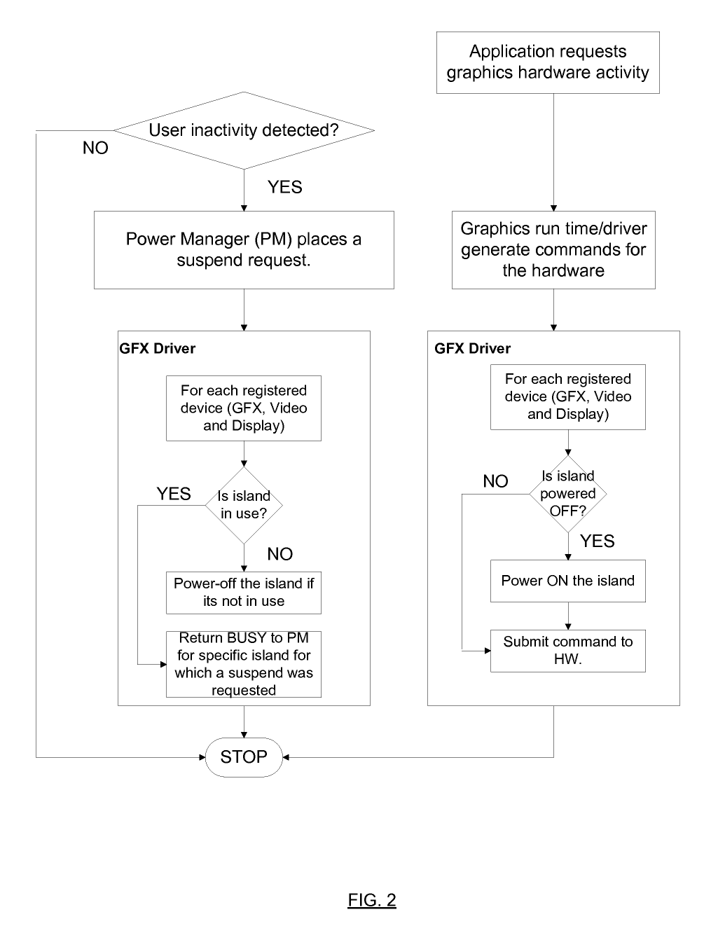

FIG. 2 shows an interaction between a GFX driver, application, and PM. After sufficient user inactivity is detected, PM puts one or more of display, video, and GFX hardware in lower-power states by issuing suspend requests. PM issues a suspend request to GFX driver to reduce power for each island that is not in use. A lower power state can be any of Dx, D0x, Sx, and SiOx states described earlier. For example, user inactivity detected can include no user interaction with a system for a period of time such as the system's touch screen, key pad, mouse, or scroll device.

GFX driver responds to the suspend request by determining whether to power-off unused GFX, video, or display hardware. GFX driver returns a BUSY indicator to the PM for the specific hardware device (i.e., “island”) for which a suspend was requested but the hardware device was in use. If the PM receives a BUSY indicator, then the PM retries to suspend the specific hardware device at a later time. If the specific hardware device is not in use when a suspend request is received, the PM powers-down the island to a lower power use state. In some cases, at least, the GFX driver powers-down the display island even if other HW accelerators are busy to reduce power consumption.

In this example, the applications are platform-state unaware and generate commands for the GFX/video hardware even when there is a chance that the display is turned off or the request renders an undisplayable image. In response to receipt of a graphics hardware activity request from an application, graphics run time and the graphics driver generate commands for the hardware. However, the PM has reduced power to at least one hardware device in the platform. Applications interact with the GFX runtime and the GFX driver to generate the commands to the platform. In the current implementations, the GFX driver powers-on the GFX/video hardware to process these commands, which results in unnecessary power consumption when the content is un-displayable.

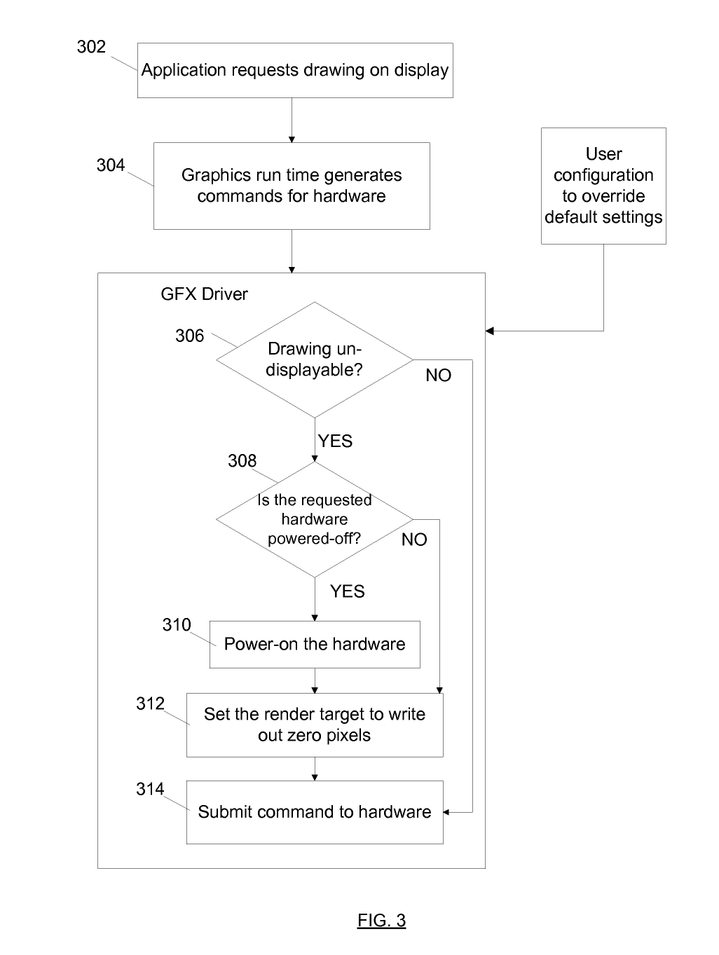

FIG. 3 depicts a process in which a driver causes the target region to be zero pixels in size when a request for drawing will not be displayed. At 302, an application requests drawing of pixels on a display. A draw call could be DrawRectangle, DrawWindow, and so forth. Graphics run time could translate the draw call into triangles with appropriate vertices. At 304, graphics run time generates commands for hardware to execute the request from the application. At 306, graphics driver determines whether the requested drawing is un-displayable. For example, the display may be in lower power mode or the drawing may be covered by a screen saver or other image or video. The display could have been turned-off by a power manager or other logic. The drawing request may be un-displayable if completely covered by another image. If the requested drawing is un-displayable, then, at block 308, the GFX driver determines whether the hardware that is to render the requested drawing is powered-off or in lower power mode.

If the hardware is powered off or in lower power mode, then the hardware is powered-on (block 310) but the render target from the hardware is set to zero pixels (block 312) so that no pixels are output from the hardware to display hardware (block 314). Powering-on the hardware even though the image is un-displayable will help to have the up-to-date image and the state information to be maintained and current when the display is turned back-on. This may save power usage by the island because the island does not perform much work, even though island is powered on. In some cases, zero pixel render target can be issued by software executed by a central processing unit to maintain the proper state management of the graphics subsystem for the client application.

In some embodiments, a video hardware engine includes both video encode and decode hardware blocks. In some embodiments, the video encode and decode hardware blocks can be power managed. In some cases, a zero pixel target can be provided as an input to a powered-up video encode hardware block or decode hardware block. In some cases, video encoders and decoders use the previous frame as reference to encode or decode the next frame. Accordingly, the zero pixel target may not be applicable or power efficient for video encode or decode operation as it may use the previous frame content. Thus, zero pixels may not be provided to video encoder or decoder block if it causes any visible artifacts.

In some embodiments, instead of a zero pixel render target, one quarter or one-sixteenth of the specified resolution can be rendered to dramatically reduce the rendering workload. The resolution can be reduced by other fractions in other amounts such as one-half.

If the drawing is displayable or the requested hardware is powered-on, then the commands are submitted to the hardware (block 314).

In some cases, a user can override GFX driver settings for a particular application. For some applications, the process of FIG. 3 is not applied and instead the process of FIG. 2 is used.

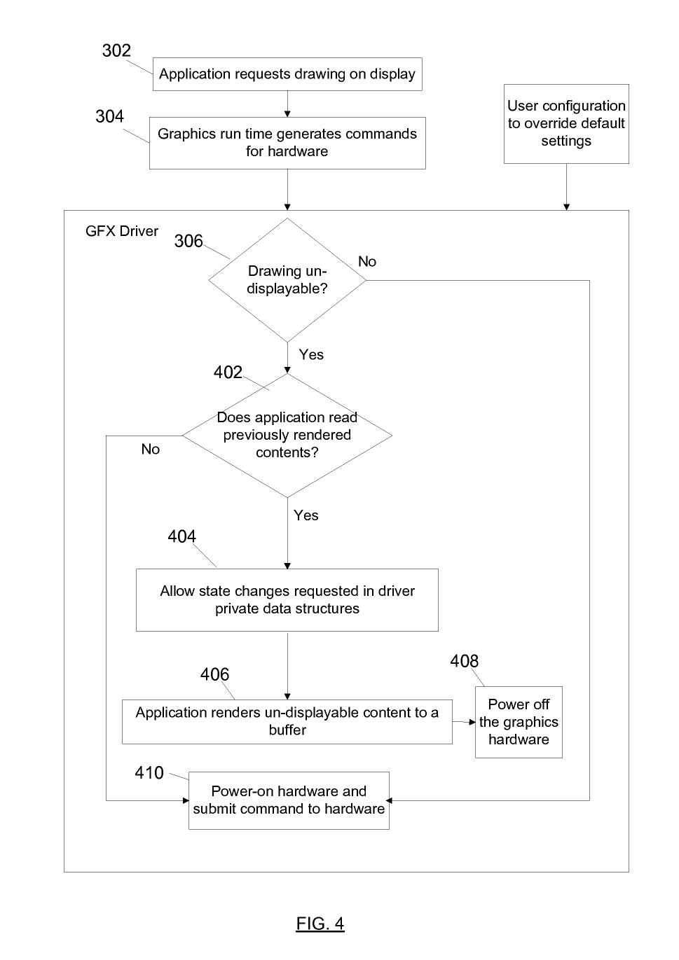

Some applications cannot tolerate rendering zero pixels as in the process of FIG. 3. For example, some applications read back rendered content and perform actions using the previously rendered content, whether the content was requested to be rendered by the same application or another application. For example, some applications generate content based on previously rendered content. FIG. 4 depicts a process that is a variation of the process of FIG. 3. In the process of FIG. 4, at block 402, the graphics driver determines whether the application that requests the drawing also relies on previously rendered content. More generically, a determination is made whether the application reads previously rendered content. Previously rendered content can include off-screen content or content that was not displayable because covered by other displayed content. For example, an application's process identifier identifies an application that reads previously rendered content. For example, if that application uses function glReadPixels, then the application tries to read previously rendered content. In some cases, the driver checks if the application or the pixel shader has accessed the rendered content in a previous frame to determine whether the application accesses previously rendered content.

If the application reads previously rendered content, then in block 404, the GFX driver allows the state changes requested by the application to occur in the GFX driver's data structures. For example, state changes can include lighting of a frame, lighting of a texture, next command or next execution to hardware, and other states. In addition, in block 406, the GFX driver permits the application to render off-screen content to a buffer. For example, 0-N frames can be buffered, where N is an integer ≧1. An application can read-back previously rendered content from the buffer.

In some cases, software-implemented graphics processing can take place to render un-displayable content to a buffer and the hardware is not powered-on. In some cases, hardware is powered-on when graphics processing is to take place and the processed items are stored in the buffer. The powered-on hardware is powered-off (or enters lower power mode) after storing the rendered drawing to the buffer (block 408). The trade-off is that software-implemented graphics processing would use the CPU instead of a graphics processing unit (GPU) and may result in more power consumption than powering-on GPU hardware.

Subsequently, the application can access the previously rendered image using a copy operation from the buffer to a memory buffer used by the application without powering-on the graphics hardware.

If the application does not read previously rendered content, the GFX driver allows the hardware to be powered-on (or fully powered-up) in block 410. If the drawing request is displayable, GFX driver allows the hardware to perform the requested actions. If the drawing request is not displayable, GFX driver issues a zero pixel target to the powered-on hardware as in the process of FIG. 3. In some cases, although not depicted, if the drawing request is not displayable, GFX driver issues a zero pixel target to be rendered using a CPU without powering on the hardware.

In some cases, a user can override GFX driver settings for a particular application. For some applications, the process of FIG. 4 is not applied and instead the process of FIG. 2 is used.

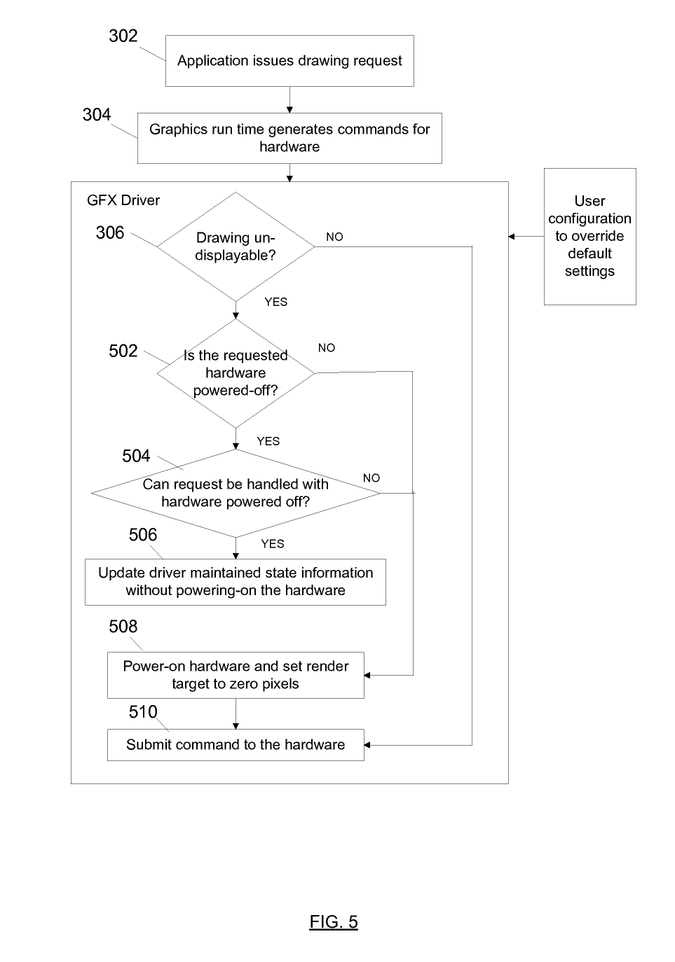

FIG. 5 depicts an example process that can be used to distinguish between applications that utilize graphics hardware and do not use graphics hardware and handle powering-on of hardware and instructions to hardware appropriately.

If a requested drawing is un-displayable (block 306) and if the hardware that is to process the requested drawing is powered-off (block 502), then a determination is made of whether the request can be handled with the hardware powered-off or in lower power mode (block 504). A lower power mode can be any of Dx, D0x, Sx, and SiOx states described earlier. For example, the hardware can remain powered-off or in lower power mode for a simple copy operation or graphics processing performed by software. However, in other cases, hardware may be powered-on. For example, to execute the drawing request, it may be more efficient from the standpoint of power consumption to power-up hardware. In some cases, the drawing request may utilize hardware so that the hardware is powered-up.

If the request can be handled without powering-on hardware (block 504), then the GFX driver's state information is updated to that which would occur had the drawing request been performed but without powering-on the hardware (block 506).

If the requested hardware is already powered-on (block 502) or the request cannot be handled without powering-on hardware (block 504), then the render target is set to zero by zero (0×0) pixels (blocks 508 and 510). In some cases, zero pixel render target can be issued by software executed by a CPU without powering on the hardware.

If the drawing is displayable, then the command is submitted to the hardware for rendering (block 510).

In some cases, a user can override GFX driver settings for a particular application. For some applications, the process of FIG. 5 is not applied and instead the process of FIG. 2 is used.

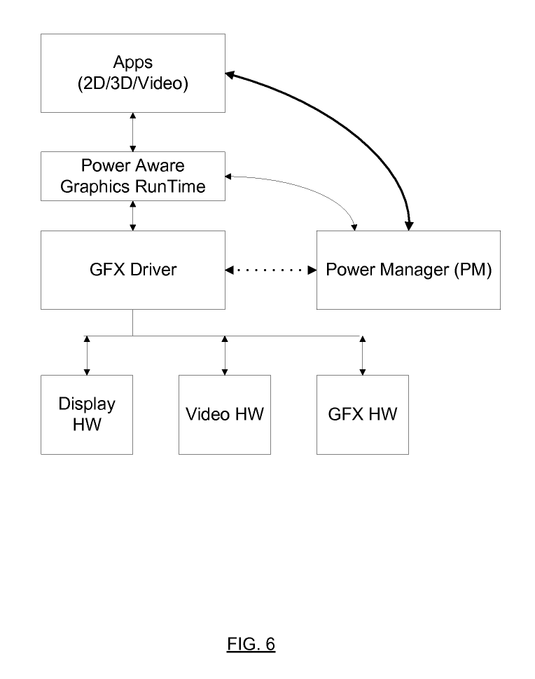

FIG. 6 depicts a system in which a power manager (PM) and applications are involved in communications concerning power-down states of hardware in the platform. PM notifies applications about platform power change to interested power-aware applications for their co-operation. When applications receive the notification from PM about platform power change, applications may co-operate by stopping their drawing operations. Power aware applications notify the PM about their inactivity so that the PM can decide which hardware to power-down. From the notifications received from applications, PM can map the HW accelerator used by the application (for example, GFX or video) and accordingly reduces power of the HW if no other application/entity is using the HW.

PM requests reduced power of a hardware accelerator by interacting with the GFX driver. In response to applications' inactivity notifications, PM can transition hardware accelerators into low power even before user inactivity is detected. Power aware graphics runtime co-operates with PM and reduces hardware requests to driver. GFX runtime can abort all the application requests. In some cases, GFX runtime rejects application requests by responding that a Platform is Not Ready to process the requests. The GFX runtime can inform the application to not generate further commands directed to hardware accelerators. During a power-up, PM could request the window manager to perform a refresh so that applications can refresh to the expected states.

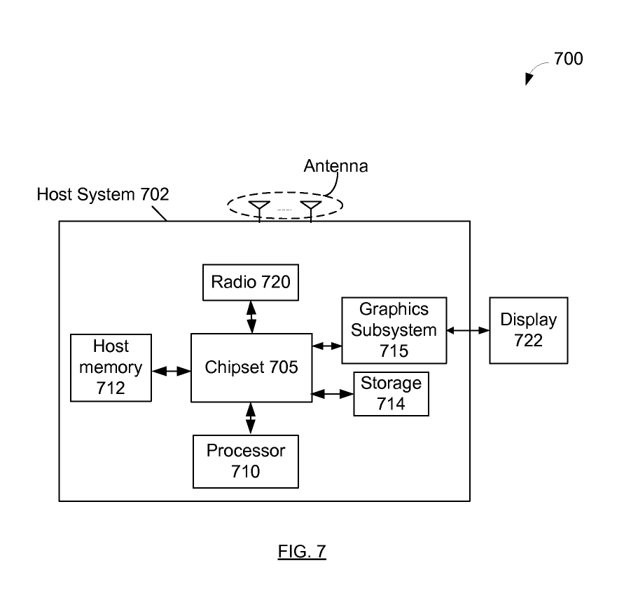

FIG. 7 depicts a system in accordance with an embodiment. System 700 may include host system 702 and display 722. Computer system 700 can be implemented in a handheld personal computer, mobile telephone, set top box, or any computing device. Host system 702 may include chipset 705, processor 710, host memory 712, storage 714, graphics subsystem 715, and radio 720. Chipset 705 may provide intercommunication among processor 710, host memory 712, storage 714, graphics subsystem 715, and radio 720. For example, chipset 705 may include a storage adapter (not depicted) capable of providing intercommunication with storage 714. For example, the storage adapter may be capable of communicating with storage 714 in conformance with any of the following protocols: Small Computer Systems Interface (SCSI), Fibre Channel (FC), and/or Serial Advanced Technology Attachment (S-ATA).

In various embodiments, processor 710 may regulate power consumption of components in graphics subsystem in accordance with techniques described herein.

Processor 710 may be implemented as Complex Instruction Set Computer (CISC) or Reduced Instruction Set Computer (RISC) processors, multi-core, or any other microprocessor or central processing unit.

Host memory 712 may be implemented as a volatile memory device such as but not limited to a Random Access Memory (RAM), Dynamic Random Access Memory (DRAM), or Static RAM (SRAM). Storage 714 may be implemented as a non-volatile storage device such as but not limited to a magnetic disk drive, optical disk drive, tape drive, an internal storage device, an attached storage device, flash memory, battery backed-up SDRAM (synchronous DRAM), and/or a network accessible storage device.

Graphics subsystem 715 may perform processing of images such as still or video for display. An analog or digital interface may be used to communicatively couple graphics subsystem 715 and display 722. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

Radio 720 may include one or more radios capable of transmitting and receiving signals in accordance with applicable wireless standards such as but not limited to any version of IEEE 802.11 and IEEE 802.16.

Although not depicted, system 700 can include access to input devices such as a touch screen, mouse, and camera.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
receiving a drawing request;
determining whether the drawing request does not include a displayable drawing request;
selectively modifying the drawing request in response to a determination that the drawing request does not include a displayable drawing request; and
outputting the drawing request.

2. The method of claim 1, wherein the selectively modifying the drawing request comprises selectively reducing a number of pixels of the drawing request.

3. The method of claim 2, wherein the selectively reducing a number of pixels of the drawing request comprises setting pixel dimensions to zero by zero and further comprising requesting powering-on of drawing acceleration hardware in response to the request.

4. The method of claim 2, wherein the selectively reducing a number of pixels of the drawing request comprises setting pixel dimensions to a fraction of dimensions of the pixels of the drawing request, wherein the fraction is less than one.

5. The method of claim 1, wherein the selectively modifying the drawing request comprises:
determining whether an issuer of the drawing request reads previously rendered graphics;
determining a state resulting from performing the drawing request; and
in response to a determination that the issuer reads previously rendered graphics, saving the determined state without performing the drawing request and storing a rendered drawing request to a buffer.

6. The method of claim 1, further comprising:
in response to the drawing request including a displayable drawing request, requesting drawing acceleration hardware to be powered-on and submitting the command to the hardware, wherein the hardware comprises one of display, video, or graphics hardware.

7. The method of claim 1, further comprising:
determining whether the drawing request can be performed with acceleration hardware associated with the drawing request remaining in lower power mode and
in response to a determination that the drawing request can be performed with acceleration hardware associated with the drawing request remaining in lower power mode, saving the determined state without performing the drawing request.

8. The method of claim 7, further comprising:
in response to a determination that the drawing request can not be performed with hardware associated with the drawing request remaining in lower power mode, requesting the associated hardware to be powered-up and submitting the drawing request to the powered-up hardware.

9. The method of claim 1, further comprising:
using an application executed by a central processing unit to perform rendering of lower complexity drawings of the drawing request independent of powering-up graphics or video hardware.

10. An apparatus comprising:
a graphics driver to:
determine whether a received drawing request does not include a displayable drawing request and
selectively modify the drawing request in response to a determination that the drawing request does not include a displayable drawing request, and
a power manager (PM) to selectively request to power-on drawing acceleration hardware in response to a drawing request and to selectively reduce power consumption of acceleration hardware in response to idleness of at least one application for a threshold period of time.

11. The apparatus of claim 10, wherein:
the PM is to decide which hardware to request to enter lower power mode based on an indication of application inactivity,
the PM is to notify at least one application about lower power state of hardware, and
the at least one application is to reduce drawing requests to the hardware in lower power states in response to the drawing request being un-displayable.

12. The apparatus of claim 10, further comprising a window manager, wherein the PM is to notify the window manager to refresh the last frame during system resume.

13. The apparatus of claim 10, wherein:
the graphics driver is to notify the PM about hardware inactivity and
the graphics driver is to request use a central processing unit to perform lower complexity graphics processing in the drawing request.

14. The apparatus of claim 10, wherein:
the graphics driver is to notify the PM of hardware inactivity and
the PM is to transition in-active hardware into lower power states.

15. The apparatus of claim 10, wherein:
to selectively modify the drawing request, the graphics driver is to set pixel dimensions to a fraction of dimensions of the pixels of the drawing request, wherein the fraction is less than one.

16. The apparatus of claim 10, wherein the graphics driver is to:
determine whether an issuer of the drawing request reads previously rendered graphics;
determine a state resulting from performing the drawing request; and
in response to a determination that the issuer reads previously rendered graphics, the graphics driver is to save the determined state without performing the drawing request and storing a rendered drawing request to a buffer.

17. The apparatus of claim 10, wherein the graphics driver is to:
request use of an application executed by a central processing unit to perform rendering of lower complexity drawings of the drawing request independent of powering-up graphics or video hardware.

18. A system comprising:
a wireless interface;
a display device; and
a computer system communicatively coupled to the display device, the computer system configured to:
receive a drawing request;
determine whether the drawing request does not include a displayable drawing request; and
selectively modify the drawing request in response to a determination that the drawing request does not include a displayable drawing request.

19. The system of claim 18, wherein to selectively reduce a number of pixels of the drawing request, the computer system is to set pixel dimensions to a fraction of dimensions of the pixels of the drawing request, wherein the fraction is less than one.

20. The system of claim 18, wherein to selectively modify the drawing request, the computer system is to:
determine whether an issuer of the drawing request reads previously rendered graphics;
determine a state resulting from performing the drawing request; and
in response to a determination that the issuer reads previously rendered graphics, save the determined state without performing the drawing request and storing a rendered drawing request to a buffer.

21. The system of claim 18, wherein the computer system is also configured to:
determine whether the drawing request can be performed with hardware in lower power mode and
in response to a determination that the drawing request can be performed with hardware associated with the drawing request remaining in lower power mode, save the determined state without performing the drawing request.

22. The system of claim 18, wherein the computer system is also configured to:
request use of an application executed by a central processing unit to perform rendering of lower complexity drawings of the drawing request independent of powering-up graphics or video hardware.
